(19) United States
(12) Patent Application Publication
(10) Pub. No.: US 2017/0154312 A1
(43) Pub. Date: Jun. 1, 2017

(54) SYSTEM AND A METHOD FOR SECURELY VERIFYING EMPLOYEE DATA

(71) Applicants: Joshua Luke Wilson, Phoenix, AZ (US); Jason Michael Baum, Phoenix, AZ (US)

(72) Inventors: Joshua Luke Wilson, Phoenix, AZ (US); Jason Michael Baum, Phoenix, AZ (US)

(21) Appl. No.: 15/360,646

(22) Filed: Nov. 23, 2016

Related U.S. Application Data
(60) Provisional application No. 62/260,372, filed on Nov. 27, 2015.

(51) Int. Cl. G06Q 10/10; H04L 29/06

(52) U.S. Cl. CPC G06Q 10/1053; H04L 63/126

(57) ABSTRACT

Embodiments of the present invention are generally directed towards providing systems and methods for verification of employee data. Specifically, embodiments of the present invention relate to a method and a system for verification of employees data while maintaining and managing security issues related to identity theft.

### CROSS-REFERENCE TO RELATED APPLICATION

The present application claims priority from provisional application number 62/260,372 entitled “A SYSTEM AND A METHOD FOR VERIFYING EMPLOYEES DATA FOR THE COMPANIES” filed Nov. 27, 2015, the content of which is incorporated by reference herein in its entirety.

### FIELD OF THE INVENTION

Embodiments of the present invention are generally directed towards providing systems and methods for securely verifying employee data. Specifically, embodiments of the present invention relate to a method and a system for verification of employees data while maintaining and managing security issues related to identity theft.

### BACKGROUND

When a person applies for a home loan, they typically fill out a credit application and submit it to a mortgage company. This application requires the applicant to disclose personal financial information including bank account numbers and balances, loan payments, credit card account numbers and balances, employment history, current salary and perhaps other information.

Mortgage companies have typically compared the financial information in the credit application with financial information obtained from a service provider (sometimes called a credit bureau). Some mortgage companies input this financial information into various formulas to produce a numeric credit score. However, verification of current salary and employment data was more difficult.

Mortgage companies were often forced to make direct contact with the employer to obtain and verify current employment data. This verification process with the employer typically required a written inquiry from the mortgage company to the employer and a written response from the employer to the mortgage company.

Similar processes are followed by prospective employer for verifying someone salary and other records. Most of such systems require SSN to verify a user. Employers are reluctant to provide such confidential information. Further, this written verification process for salary and employment data was time-consuming and sometimes subject to fraud.

It was also expensive because employers with thousands of employees were required to dedicate a portion of their Human Resources Department to the verification process.

Therefore, there is need in the art systems and methods for securely verifying employee data without the requirement for utilizing sensitive or confidential information associated with an employee. These and other features and advantages of the present invention will be explained and will become obvious to one skilled in the art through the summary of the invention that follows.

### SUMMARY OF THE INVENTION

Accordingly, it is an aspect of the present invention to provide systems and methods for providing automated keychain grouping and updating in order to provide efficient control over and management of security keychains.

According to an embodiment of the present invention, a system for securely verifying employee data comprises: a verification module, comprising computer-executable code stored in non-volatile memory; and a processor; and wherein said verification module and said processor are operably connected and said verification module is configured instruct said processor to: receive an employee registration request, wherein said employee registration request comprises information associated with an employee; parse said employee registration request for said information associated with said employee; generate an employee registration, based at least in part on said information associated with said employee; receive a company information association request, wherein said company information association request comprises information about employment of said employee with a company; associate said information about employment of said employee with said company with said employee registration; generate a unique identifier for said employee based at least in part on said information about employment of said employee with said company and said information associated with said employee; and store an employee record, comprising said unique identifier and say employee registration.

According to an embodiment of the present invention, the verification module is further configured to instruct said processor to: receive an employment verification request from a requesting entity; parse employee information from said employment verification request; identify one or more key identifiers from said employee information; retrieve employee information, based at least in part on said one or more key identifiers; generate a verification confirmation, wherein said verification confirmation confirms said employees employment with said company; and transmit said verification confirmation to said requesting entity.

According to an embodiment of the present invention, the information associated with said employee comprises, a first name, a last name, a birth date, and a company name.

According to an embodiment of the present invention, the information about employment of said employee with a company comprises, a start date of employment, salary information and a work history.

According to an embodiment of the present invention, the information about employment of said employee with a company further comprises a termination date.

According to an embodiment of the present invention, the one or more key identifiers include a first name, a last name, a birthday and a company name.

According to an embodiment of the present invention, the one or more key identifiers consists of a first name, a last name, a birthday and a company name.

According to an embodiment of the present invention, the verification confirmation comprises a start date, a work history and a salary.

According to an embodiment of the present invention, the information about employment of said employee with a company comprises a position held by said employee.

According to an embodiment of the present invention, a computer-implemented and effected method for securely verifying employee data comprises the steps of: receiving an employee registration request, wherein said employee registration request comprises information associated with an employee; parsing said employee registration request for said information associated with said employee; generating an employee registration, based at least in part on said information associated with said employee; receiving a company information association request, wherein said company information association request comprises information about employment of said employee with a company; associating said information about employment of said employee with said company with said employee registration; generating a unique identifier for said employee based at least in part on said information about employment of said employee with said company and said information associated with said employee; and storing an employee record, comprising said unique identifier and say employee registration.

According to an embodiment of the present invention, the method further comprises the steps of: receiving an employment verification request from a requesting entity; parsing employee information from said employment verification request; identifying one or more key identifiers from said employee information; retrieving employee information, based at least in part on said one or more key identifiers; generating a verification confirmation, wherein said verification confirmation confirms said employees employment with said company; and transmitting said verification confirmation to said requesting entity.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 illustrates a schematic of a system for securely verifying employee data, in accordance with an embodiment of the present invention;

FIG. 4 illustrates a schematic of a system for securely verifying employee data, in accordance with an embodiment of the present invention;

FIG. 5 is a process flow of an exemplary method in accordance with embodiments of the present invention; and

FIG. 6 is a process flow of an exemplary method in accordance with embodiments of the present invention.

### DETAILED SPECIFICATION

Embodiments of the present invention are generally directed towards providing systems and methods for verification of employee data. Specifically, embodiments of the present invention relate to a method and a system for verification of employees data while maintaining and managing security issues related to identity theft.

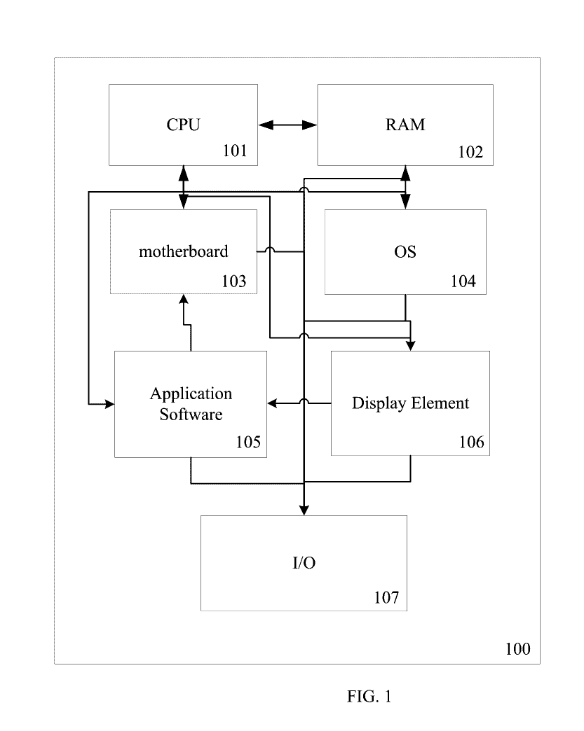

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smart phones, laptops, mobile computing devices and tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

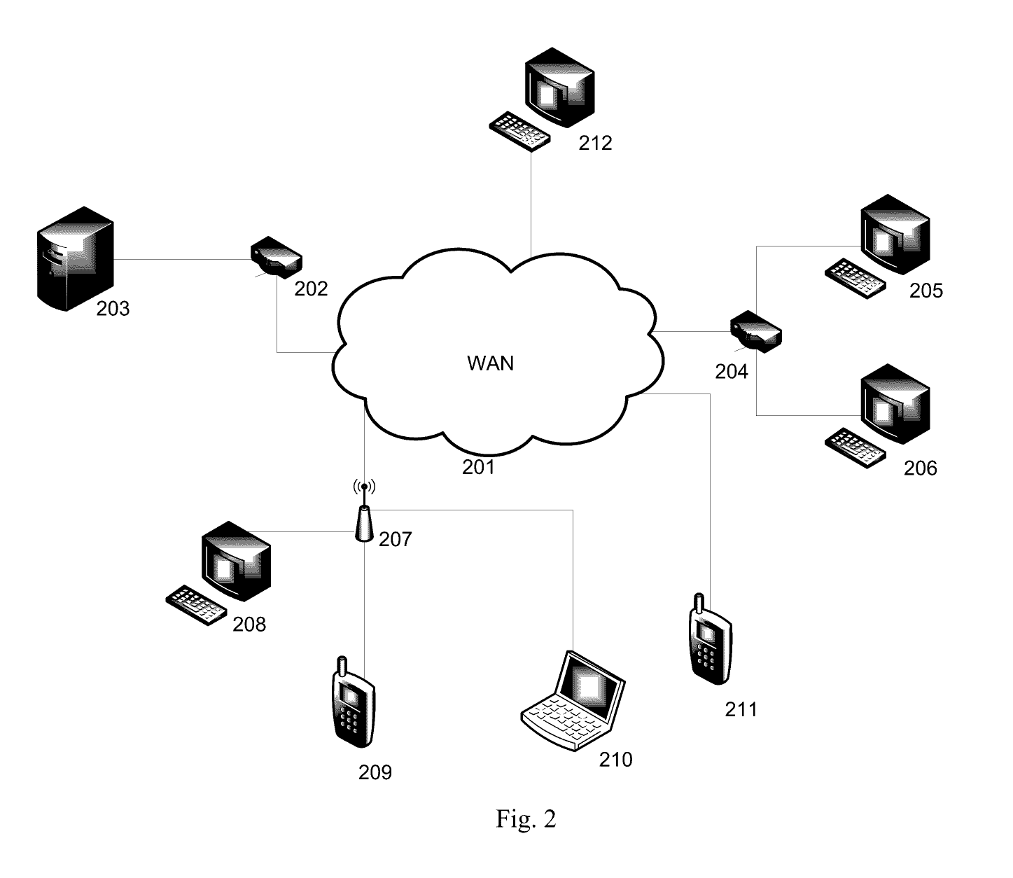

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a Network 201 (e.g., the Internet, a LAN, WiFi, Bluetooth, etc.). Applications in server 203 may also be used to manipulate information stored remotely and process and analyze data stored remotely across a Network 201 (e.g., the Internet, a LAN, WiFi, Bluetooth, etc.).

According to an exemplary embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via Network 201 or other network in numerous ways. For instance, a component may connect to the system i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a component may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

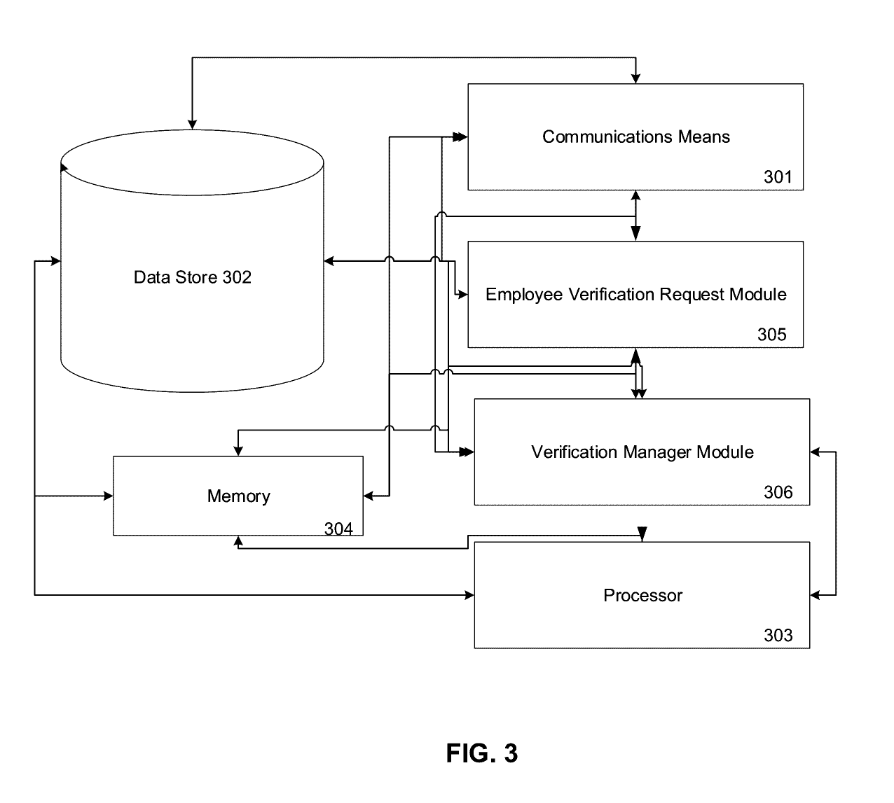

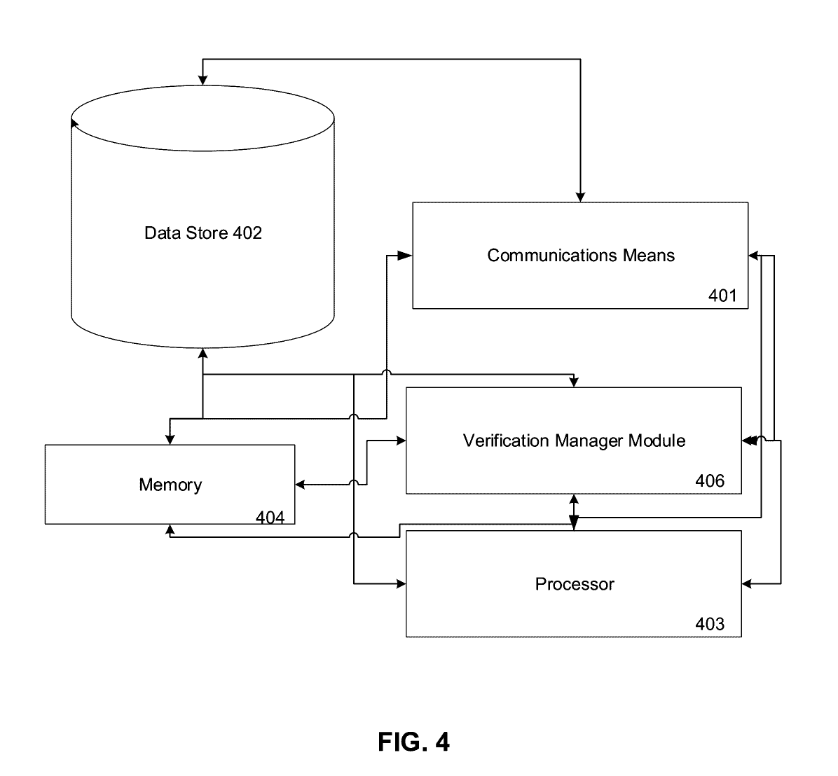

Turning to FIG. 3, according to an embodiment of the present invention, a system for providing automated keychain grouping and updating is comprised of one or more communications means 301, one or more data stores 302, a processor 303, memory 304, an employee verification request module 405 and a verification manager module 306. In FIG. 4, according to an embodiment of the present invention, a system for providing automated keychain grouping and updating is comprised of one or more communications means 401, one or more data stores 402, a processor 403, memory 404 and a verification manager module 406. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, circuitry purposed for the means of communicating data, voice or video communications (or any combination thereof) over one or more networks or to one or more peripheral devices attached to the system. Appropriate communications means may include, but are not limited to, circuitry and or other electronics or combinations of software, hardware and individual elements thereof, each providing for one or more wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the employee verification request module is configured to receive and process requests for employee verification and requests related thereto. An employee verification request module may process requests by employees to submit their information for employment verification, requests by companies to provide information related to an employee's employment with the company, and requests from employers looking to verify or otherwise validate information presented to the employer regarding the employee (or potential employee). Interaction with the employee verification request module may be through direct access (such as graphical user interfaces via a website) or indirectly, such as access through requests submitted and processed through one or more application programming interfaces (APIs) provided by the system and interacted with through a third party system for transacting such requests.

According to an embodiment of the present invention, the employee verification request module may be further configured to process the requests when they are received. Processing the requests may include parsing out the particular request type and information associated with that request. For instance, a request may be received related to an employee wanting to submit their information to the system in order to have an employee profile generated. The request to have a profile generated may identify, for instance, the type of request and provide information required by the submission, such as first name, last name, name of the company with which employs the employee, and birthday. One of ordinary skill in the art would appreciate that there are numerous types of information that could be provided in such a request, and embodiments of the present invention are contemplated for use with any appropriate type of information.

According to an embodiment of the present invention, the verification manager module is configured to process information derived from the various requests submitted to the system and generate employee and company records for use in performance of validating employment verification requests. The verification manager module is in charge of associating with the user a unique identifier based on key information about a user. In a preferred embodiment, key information may include, but is not limited to, first name, last name, birthdate, employing company name, or any combination thereof. In other embodiments, key information may include, but is not limited to, employment start date, salary, job title, employment termination date, middle name, company unique identifier, employee address, company address, or any combination thereof. One of ordinary skill in the art would appreciate that there are numerous key identifiers that could be utilized with embodiments of the present invention, and embodiments of the present invention are contemplated for use with any appropriate key identifiers.

One of the purposes of using key identifiers to generate a unique identifier for employees is so that the system can utilize and define employees without need to reference information that would potentially jeopardize the security of the employee, such as social security number, bank account numbers, or other sensitive information that could be used to steal an employee's identity. Advantageously, the system can provide a means for allowing companies or others to verify the employee's employment information without releasing sensitive private information about the employee.

According to an embodiment of the present invention, in the rare case where there is a conflict in key identifiers such that there may be more than two individuals that match the key identifiers (e.g., two employees with the same first name, last name, employer and birthdate), the system can be configured to request additional key identifiers to ensure the two employees can be identified appropriately. For instance, the system can be configured to utilize additional information the system has about each employee (e.g., middle name, address, start date, salary, job title) to further distinguish the employees and generate a unique identifier for each of those employees based on the additional information.

### Exemplary Embodiments

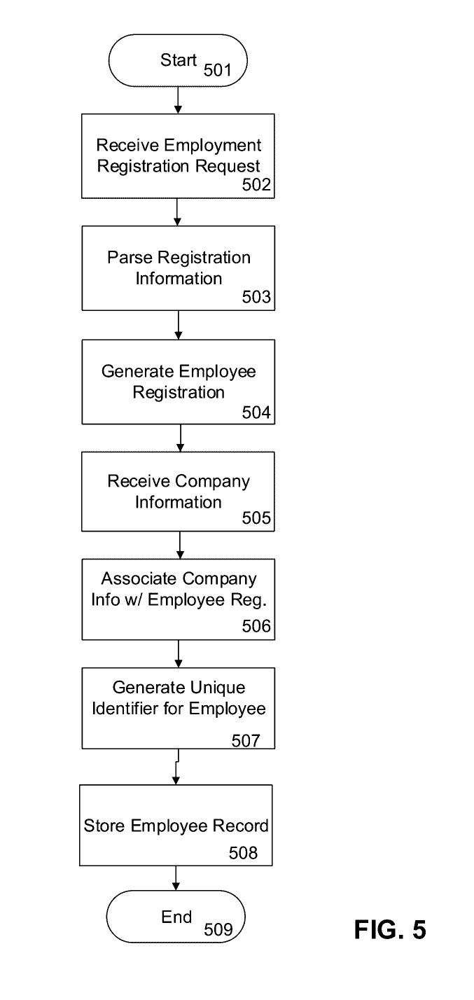

Turning now to FIG. 5, an exemplary method for securely verifying employee data is shown. The process starts at step 501 with a user engaging the system for an employment registration request. At step 502, the system receives the employment registration request. Generally, the request is received over a communications means, where the data is received from a remote computing device operated by the user and interpreted by the system.

At step 503, the system parses the registration information. In general, a request comprises an identification of the type of request submitted (i.e., in this case, an employment registration request) and a package of information. In an employment registration request, the package of information is provided by an employee or other user involved with generating an employee profile. The package of information may include, but is not limited to, first name, last name, middle name, birth date of employee, address of employee, company name, address of company, start date of employment, end date of employment, salary information, job title, department, or any combination thereof. One of ordinary skill in the art would appreciate that there are numerous types of information that could be included in the package of information, and embodiments of the present invention are contemplated for use with any appropriate information. At step 504, the system generates an employee registration based on the package of information received.

At step 505, the system receives company information from a company identified in the employment registration request. The company information may be provided, for instance, directly from the company employing the employee associated with the request. Company information may supplement the information provided by the employee or otherwise supplant the information provided by the employee. Advantageously, where the company verifies and provides information, the validity of the information is ensured and the system can confirm the actual validity of the registered employee's identity and information. At step 506, the system associates the information provided by the company with the employee registration.

At step 507, now that the system has all the information required to generate and confirm the employee, the system will generate a unique identifier for the employee and store the information (step 508) for later retrieval and use. At this point, the process terminates at step 509.

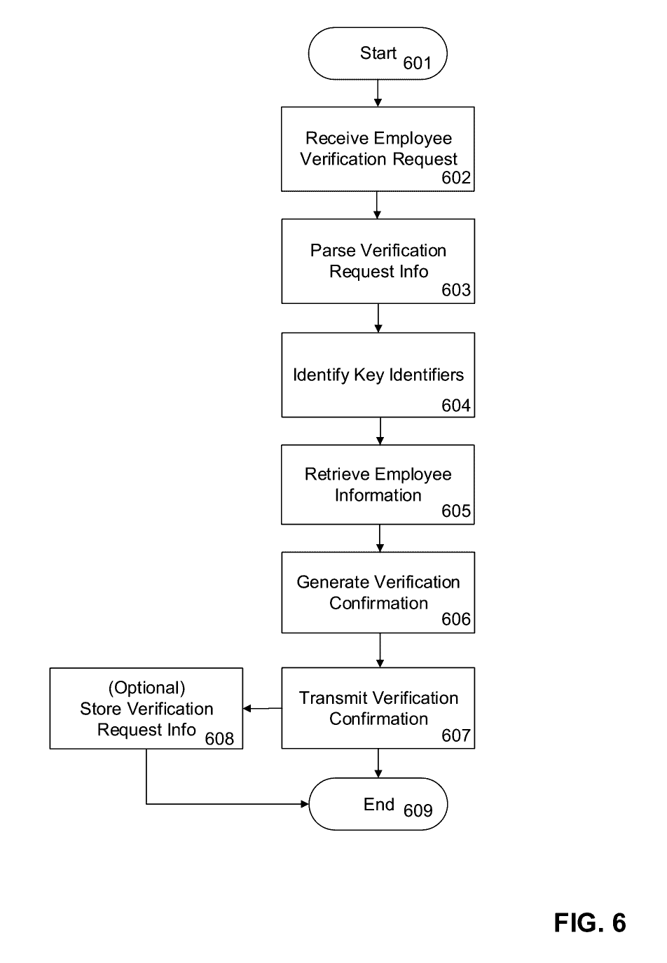

Turning now to FIG. 6, an exemplary method for securely verifying employee data is shown. The process starts at step 601 with a user engaging the system for verifying an employee's information. At step 602, the system receives the employment verification request. Generally, the request is received over a communications means, where the data is received from a remote computing device operated by the user and interpreted by the system.

At step 603, the system parses the verification request information. In general, a verification request comprises information required to identify an employee via one or more key identifiers. As previously noted herein, key identifiers may include, but are not limited to, first name, last name, middle name, birthdate, company name, start date, job title, or any combination thereof.

At step 604, the system identifies the key identifiers provided in the verification request. The system uses these key identifiers to identify the unique identifier associated with the employee whose information is to be retrieved.

At step 605, the system retrieves the employee's information, via use of the unique identifier identified via the key identifiers. The system will then generate a verification confirmation, assuming the employees information was retrievable via the key identifiers provided. If the key identifiers did not identify an employee, the process could send an error or otherwise reject the request. In still further embodiments, if more than one employee was identified with a set of key identifiers, the system could use additional key identifiers (or request additional key identifiers) in order to identify the correct employee.

At step 607, once generated, the system will transmit the verification confirmation to the requesting user/entity. Optionally, at step 608, the system can store information about verification requests. Information about verification requests could be used by employees to see who or how often others have requested to have their information verified. At this point, the process can terminate at step 609.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for securely verifying employee data, the system comprising:
a verification module, comprising computer-executable code stored in non-volatile memory; and
a processor; and
wherein said verification module and said processor are operably connected and said verification module is configured instruct said processor to:
receive an employee registration request, wherein said employee registration request comprises information associated with an employee;
parse said employee registration request for said information associated with said employee;
generate an employee registration, based at least in part on said information associated with said employee;
receive a company information association request, wherein said company information association request comprises information about employment of said employee with a company;
associate said information about employment of said employee with said company with said employee registration;
generate a unique identifier for said employee based at least in part on said information about employment of said employee with said company and said information associated with said employee; and
store an employee record, comprising said unique identifier and say employee registration.

2. The system of claim 1, wherein said verification module is further configured to instruct said processor to:
receive an employment verification request from a requesting entity;
parse employee information from said employment verification request;
identify one or more key identifiers from said employee information;
retrieve employee information, based at least in part on said one or more key identifiers;
generate a verification confirmation, wherein said verification confirmation confirms said employees employment with said company; and
transmit said verification confirmation to said requesting entity.

3. The system of claim 1, wherein said information associated with said employee comprises, a first name, a last name, a birth date, and a company name.

4. The system of claim 1, wherein said information about employment of said employee with a company comprises, a start date of employment, salary information and a work history.

5. The system of claim 4, wherein said information about employment of said employee with a company further comprises a termination date.

6. The system of claim 2, wherein said one or more key identifiers include a first name, a last name, a birthday and a company name.

7. The system of claim 2, wherein said one or more key identifiers consists of a first name, a last name, a birthday and a company name.

8. The system of claim 2, wherein said verification confirmation comprises a start date, a work history and a salary.

9. The system of claim 2, wherein said information about employment of said employee with a company comprises a position held by said employee.

10. A computer-implemented and effected method for securely verifying employee data, the method comprising the steps of:
receiving an employee registration request, wherein said employee registration request comprises information associated with an employee;
parsing said employee registration request for said information associated with said employee;
generating an employee registration, based at least in part on said information associated with said employee;
receiving a company information association request, wherein said company information association request comprises information about employment of said employee with a company;
associating said information about employment of said employee with said company with said employee registration;
generating a unique identifier for said employee based at least in part on said information about employment of said employee with said company and said information associated with said employee; and
storing an employee record, comprising said unique identifier and say employee registration.

11. The method of claim 10, further comprising the steps of:
receiving an employment verification request from a requesting entity;
parsing employee information from said employment verification request;
identifying one or more key identifiers from said employee information;
retrieving employee information, based at least in part on said one or more key identifiers;
generating a verification confirmation, wherein said verification confirmation confirms said employees employment with said company; and
transmiting said verification confirmation to said requesting entity.

12. The method of claim 10, wherein said information associated with said employee comprises, a first name, a last name, a birth date, and a company name.

13. The method of claim 10, wherein said information about employment of said employee with a company comprises, a start date of employment, salary information and a work history.

14. The method of claim 10, wherein said information about employment of said employee with a company further comprises a termination date.

15. The method of claim 10, wherein said one or more key identifiers include a first name, a last name, a birthday and a company name.

16. The method of claim 10, wherein said one or more key identifiers consists of a first name, a last name, a birthday and a company name.

17. The method of claim 10, wherein said verification confirmation comprises a start date, a work history and a salary.

18. The method of claim 10, wherein said information about employment of said employee with a company comprises a position held by said employee.
